(19) United States
(12) Patent Application Publication
(10) Pub. No.: US 2017/0173627 A1
(43) Pub. Date: Jun. 22, 2017

(54) ELECTROSTATIC POWDER COATING METHOD AND POWDER COATING MATERIAL

(71) Applicant: FUJI XEROX CO., LTD., Tokyo (JP)

(72) Inventors: Masato MIKAMI, Kanagawa (JP); Susumu YOSHINO, Kanagawa (JP); Takeshi AGATA, Kanagawa (JP)

(73) Assignee: FUJI XEROX CO., LTD., Tokyo (JP)

(21) Appl. No.: 15/096,642

(22) Filed: Apr. 12, 2016

(30) Foreign Application Priority Data
Dec. 18, 2015 (JP) 2015-247991

(51) Int. Cl. B05D 1/00; C09D 167/02; B05D 3/00; C09D 5/03

(52) U.S. Cl. CPC B05D 1/007; C09D 5/031; C09D 167/02; B05D 3/007

(57) ABSTRACT

An electrostatic powder coating method includes spraying a charged powder coating material that includes powder particles which contain a thermosetting resin and a thermosetting agent, and which have an average circularity of 0.940 to 0.950 to electrostatically attach the powder coating material to an object to be coated; and heating the powder coating material that is electrostatically attached to the object to be coated to thereby form a coating film, wherein an average circularity Sc of the powder particles in the powder coating material that is electrostatically attached to the object to be coated and an average circularity So of the powder particles in the powder coating material before being sprayed satisfy a relationship of Expression: So×0.90≦Sc≦So×1.05.

### CROSS-REFERENCE TO RELATED APPLICATIONS

This application is based on and claims priority under 35 USC 119 from Japanese Patent Application No. 2015-247991 filed Dec. 18, 2015.

### BACKGROUND

1. Technical Field

The present invention relates to an electrostatic powder coating method and a powder coating material.

2. Related Art

Recently, in a powder coating technology using a powder coating material, the discharge amount of a volatile organic compound (VOC) is reduced in a coating step, and the powder coating material which has not been attached to an object to be coated is collected after coating and is able to be reused, and thus, the powder coating technology has attracted attention from the viewpoint of the global environment. For this reason, various powder coating materials have been studied.

### SUMMARY

According to an aspect of the invention, there is provided an electrostatic powder coating method, including:

spraying a charged powder coating material that includes powder particles which contain a thermosetting resin and a thermosetting agent, and which have an average circularity of 0.940 to 0.950 to electrostatically attach the powder coating material to an object to be coated; and

heating the powder coating material that is electrostatically attached to the object to be coated to thereby form a coating film,

wherein an average circularity Sc of the powder particles in the powder coating material that is electrostatically attached to the object to be coated and an average circularity So of the powder particles in the powder coating material before being sprayed satisfy a relationship of Expression: So×0.90≦Sc≦So×1.05.

### DETAILED DESCRIPTION

Hereinafter, exemplary embodiments which are an example of the invention will be described in detail.

Electrostatic Powder Coating Method

An electrostatic powder coating method according to this exemplary embodiment, includes a step (hereinafter, referred to as an “attachment step”) of spraying a charged powder coating material including powder particles which contain a thermosetting resin and a thermosetting agent, and have an average circularity of 0.940 to 0.950 to electrostatically attach the powder coating material to an object to be coated, and a step (hereinafter, referred to as a “baking step”) of heating the powder coating material which is electrostatically attached to the object to be coated to thereby form a coating film.

Then, the average circularity Sc of the powder particles (hereinafter, also referred to as “attached powder particles”) in the powder coating material (hereinafter, also referred to as an “attached powder coating material”) which is electrostatically attached to the object to be coated and the average circularity So of the powder particles (hereinafter, also referred to as “powder particles before being sprayed”) in the powder coating material before being sprayed (hereinafter, also referred to as an “powder coating material before being sprayed”) satisfy a relationship of Expression: So×0.90≦Sc≦So×1.05.

Furthermore, the powder coating material may be either a transparent powder coating material (a clear coating material) which does not contain a colorant in powder particles or a colored powder coating material which contains a colorant in powder particles.

In the electrostatic powder coating method according to this exemplary embodiment, a variation in the smoothness of the coating film which occurs at the time of storing and reusing the powder coating material collected without being electrostatically attached to the object to be coated is prevented by the method described above. The reason is assumed as follows.

In the related art, in an electrostatic powder coating method, for example, a powder coating material is sprayed by using an electrostatic powder coating machine or the like, such as a corona gun, a tribo gun, and a bell gun. Then, in the sprayed powder coating material, the powder coating material which has not been electrostatically attached to an object to be coated is collected and is reused. In the reusing, there are a case where the collected powder coating material is independently reused and a case where the collected powder coating material is reused by being mixed with a (unused) powder coating material before being sprayed. Then, a powder coating material including only the collected powder coating material and a mixed powder coating material in which the collected powder coating material is mixed with the (unused) powder coating material before being sprayed may be stored and reused.

However, smoothness of a coating film is affected not only by melting properties or the like of a thermosetting resin contained in the powder particles of the powder coating material, but also by the average circularity of the powder particles in the powder coating material which is electrostatically attached to the object to be coated. That is, according to the average circularity, the melting properties of the powder particles are changed, and the smoothness of the coating film also varies. For this reason, the average circularity of the powder particles (hereinafter, also referred to as “collected powder particles”) in the powder coating material (hereinafter, also referred to as a “collected powder coating material”) which is collected without being electrostatically attached to the object to be coated is remarkably different from the average circularity of the powder particles in the (unused) powder coating material before being sprayed, a variation in the smoothness of the coating film occurs at the time of performing electrostatic powder coating by reusing the powder coating material which is collected without being electrostatically attached to the object to be coated. In particular, the average circularity of the powder particles affects fluidity of the powder coating material. Specifically, in the case where the average circularity of the powder particles is high, and the powder particles are approximately in the shape of a sphere (in the case where the average circularity of the powder particles is set to be greater than or equal to 0.94), the fluidity of the powder coating material tends to be high, but in the case where the average circularity of the powder particles is greater than or equal to 0.96, closely filling properties of the powder particles becomes high, and thus, fluidity after storing the powder coating material easily decreases. In addition, in the case where the average circularity of the powder particles is different, a difference occurs in an attachment state with respect to the object to be coated at the time of electrostatically attaching the powder coating material to the object to be coated, and thus, an influence on the smoothness of the coating film tends to increase. Accordingly, a variation in the smoothness of the coating film also tends to increase. A variation in the smoothness of the coating film tends to remarkably occur as the film thickness becomes thinner.

Therefore, the average circularity of the powder particles (that is, the attached powder particles) is set to be from 0.940 to 0.950, and the average circularity Sc of the attached powder particles and the average circularity So of the powder particles before being sprayed are set to satisfy a relationship of Expression: So×0.90≦Sc≦So×1.05. Satisfying the relationship indicates that there is no or a small change between the average circularity Sc of the attached powder particles and the average circularity So of the powder particles before being sprayed. That is, satisfying the relationship indicates that the powder coating material is electrostatically attached to the object to be coated in a state of being close to the average circularity So of the powder particles before being sprayed. Then, in the case where powder coating material is electrostatically attached to the object to be coated in a state of being close to the average circularity So of the powder particles before being sprayed, there is no change or a small change between the average circularity of the collected powder particles in the powder coating material which has not been electrostatically attached to the object to be coated and the average circularity So of the powder particles before being sprayed.

In addition, setting the average circularity of the powder particles (that is, the attached powder particles) to be from 0.940 to 0.950 and setting the average circularity Sc of the attached powder particles and the average circularity So of the powder particles before being sprayed to satisfy the relationship described above indicate that no difference or a small difference in the fluidity after being stored between the total powder coating material before being sprayed and the total collected powder coating material. Accordingly, a difference in the attachment state with respect to the object to be coated after being stored between the total electrostatically attached powder coating material before being sprayed and the total collected powder coating material rarely occurs.

For this reason, even when the electrostatic powder coating is performed by reusing the collected powder coating material after being stored, a change in the melting properties of the powder particles in the powder coating material which is electrostatically attached to the object to be coated is prevented.

From the reason described above, in the electrostatic powder coating method this exemplary embodiment, it is assumed that a variation in the smoothness of the coating film which occurs at the time of storing and reusing the powder coating material collected without being electrostatically attached to the object to be coated is prevented. In particular, it is assumed that even in the case where a thin coating film in which a variation in smoothness easily occurs is formed, a variation in the smoothness of the coating film is prevented.

In the electrostatic powder coating method according to this exemplary embodiment, the average circularity of the powder particles before being sprayed is from 0.940 to 0.950, and is preferably from 0.942 to 0.948 from the viewpoint of preventing a variation in the smoothness of the coating film.

In the electrostatic powder coating method according to this exemplary embodiment, the average circularity Sc of the attached powder particles and the average circularity So of the powder particles before being sprayed satisfy a relationship of Expression: So×0.90≦Sc≦So×1.05, and preferably satisfy a relationship of Expression: So×0.95≦Sc≦So×1.02 from the viewpoint of preventing a variation in the smoothness of the coating film.

Furthermore, the average circularity of the powder particles is measured by using a flow type particle image analyzer “FPIA-3000 (manufactured by Sysmex Corporation)”. Specifically, 0.1 ml to 0.5 ml of a surfactant (alkyl benzene sulfonate) as a dispersant is added into 100 ml to 150 ml of water obtained by removing solid impurities in advance, and 0.1 g to 0.5 g of a measurement sample is further added thereto. A suspension in which the measurement sample is dispersed is subjected to a dispersion process with an ultrasonic dispersion device for 1 minute to 3 minutes, and concentration of the dispersion is from 3,000 particles/μl to 10,000 particles/μl. Regarding this dispersion, the average circularity of the powder particles is measured by using the flow type particle image analyzer.

Here, the average circularity of the powder particles is a value obtained by determining a circularity (Ci) of each of n particles measured for the powder particles and then calculated by the following equation. However, in the following expression, Ci represents circularity (=circumference length of a circle equivalent to a projected area of the particle/circumference length of a particle projection image), and fi represents frequency of the powder particles.

$$Average circularity ( Ca ) = ( {\sum }_{i = 1}^{n} ( Ci \times fi ) ) / {\sum }_{i = 1}^{n} ( fi ) \qquad Expression 1$$

Here, examples of a method for setting the average circularity Sc of the attached powder particles and the average circularity So of the powder particles before being sprayed to satisfy the relationship of the expression described above include 1) reducing the diameter of the powder particles of the powder coating material before being sprayed (for example, setting a volume average particle diameter Do of the powder particles before being sprayed to be from 3 μm to 10 μm), 2) narrowing the particle diameter distribution of the powder particles before being sprayed (for example, setting a volume particle diameter distribution index GSDv of the powder particles before being sprayed to be less than or equal to 1.50), 3) adding an external additive to the powder coating material before being sprayed (for example, adding silica particles to the powder coating material), and 4) uniformizing the charging properties of the powder coating material before being sprayed (the powder particles before being sprayed) (that is, narrowing a charge distribution of the powder coating material before being sprayed (the powder particles before being sprayed)) by combining the methods described above, or the like.

Hereinafter, the details of the electrostatic powder coating method according to this exemplary embodiment will be described.

Attachment Step

In the attachment step, in the powder coating material (the powder coating material before being sprayed) including the powder particles (the powder particles before being sprayed) which contain the thermosetting resin and the thermosetting agent, the charged powder coating material is sprayed, and the powder coating material is electrostatically attached to the object to be coated.

Specifically, in the attachment step, for example, the charged powder coating material is sprayed from the spray port of the electrostatic powder coating machine in a state where an electrostatic field is formed between a spray port of a electrostatic powder coating machine and a surface to be coated of the object to be coated (a surface having conductivity), and the powder coating material is electrostatically attached to a surface to be coated of the object, and thus, a film of the powder coating material is formed. That is, for example, a voltage is applied by setting the surface of the object which is grounded to a positive electrode and the electrostatic powder coating machine to a negative electrode, the electrostatic field is formed in both of the electrodes, and the charged powder coating material is electrostatically attached to the surface of the object by being flown, and thus, the film of the powder coating material is formed.

Furthermore, the attachment step may be performed while relatively moving the spray port of the electrostatic powder coating machine and the surface to be coated of the object.

Here, for example, a known electrostatic powder coating machine such as a corona gun (a coating machine which sprays a charged powder coating material in corona discharge), a tribo gun (a coating machine which sprays a powder coating material in friction charge), and a bell gun (a coating machine which centrifugally sprays a charged powder coating material in corona discharge or friction charge) is able to be used as the electrostatic powder coating machine. Then, spray conditions for excellent coating may be a setting range of each of the guns.

The film thickness of the powder coating material which is attached to the coating surface of the object to be coated may be from 10 μm to 150 μm (preferably, from 15 μm to 100 μm) from the viewpoint of setting the average circularity Sc of the attached powder particles and the average circularity So of the powder particles before being sprayed to satisfy the expression described above and preventing a variation in the smoothness of the coating film.

Baking Step

In the baking step, the powder coating material which is electrostatically attached to the object to be coated is heated, and thus, the coating film is formed. Specifically, the powder particles of the film of the powder coating material are melted and cured by heating, and thus, the coating film is formed.

A heating temperature (a baking temperature) is selected according to the type of powder coating material. As an example, the heating temperature (the baking temperature) is preferably from 90° C. to 250° C., is more preferably from 100° C. to 220° C., and is even more preferably from 120° C. to 200° C. Furthermore, a heating time (a baking time) is adjusted according to the heating temperature (the baking temperature).

Formation of the coating film, that is, coating of the object to be coated is performed, through the steps described above. Furthermore, the attachment and the heating (the baking) of the powder coating material may be simultaneously performed.

Here, the object to be coated which is a target product to be coated with the powder coating material is not particularly limited, and examples of the object to be coated include various metal components, ceramic components, resin components, and the like. The target product may be an unmolded product before being molded into each product such as a plate-shaped product and a linear product, or may be a molded product molded for electronic components, road vehicles, interior and exterior architectural materials, and the like. In addition, the target product may be a product whose surface to be coated is subjected to a surface treatment such as a primer treatment, a plating treatment, and electrodeposition coating, in advance.

Powder Coating Material

The powder coating material according to this exemplary embodiment includes the powder particles which contain the thermosetting resin and the thermosetting agent, and have an average circularity of 0.940 to 0.950, and the average circularity Sc of the powder particles in the powder coating material which is electrostatically attached to the object to be coated and the average circularity So of the powder particles in the powder coating material before being sprayed satisfy a relationship of Expression: So×0.90≦Sc≦So×1.05 (preferably, a relationship of Expression: So×0.95≦Sc≦So×1.02).

Furthermore, in the powder coating material according to this exemplary embodiment, satisfying the expression described above indicates that in the conditions of the electrostatic powder coating method which will be described in the section of “Electrostatic Powder Coating” in the following example as conditions of spraying the powder coating material and electrostatically attaching the powder coating material to the object to be coated, when the powder coating material is sprayed and the powder coating material is electrostatically attached to the object to be coated, the average circularity Sc of the powder particles in the powder coating material which is electrostatically attached to the object to be coated and the average circularity So of the powder particles in the powder coating material before being sprayed satisfy the expression described above.

Hereinafter, the details of the powder coating material used in the electrostatic powder coating method according to this exemplary embodiment (the powder coating material before being sprayed) and the powder coating material according to this exemplary embodiment will be collectively described. Furthermore, hereinafter, both of the powder coating materials will be described by being referred to as the powder coating material according to this exemplary embodiment.

The powder coating material according to this exemplary embodiment includes the powder particles. The powder coating material may include an external additive, if necessary.

Powder Particles

The powder particles contain the thermosetting resin and the thermosetting agent. The powder particles may contain a colorant, and other additives, if necessary.

Thermosetting Resin

The thermosetting resin is a resin including a thermosetting reaction group. In the related art, as the thermosetting resin, various types of resin used in the powder particles of the powder coating material are used.

The thermosetting resin may preferably be a water-insoluble (hydrophobic) resin. When the water-insoluble (hydrophobic) resin is used as the thermosetting resin, environmental dependence of a charging property of the powder coating material (powder particle) is decreased. When preparing the powder particle by an aggregation and coalescence method, the thermosetting resin is preferably a water-insoluble (hydrophobic) resin, in order to perform emulsification and dispersion in an aqueous medium. The water-insolubility (hydrophobicity) means a dissolved amount of a target material with respect to 100 parts by weight of water at 25° C. is less than 5 parts by weight.

Examples of the thermosetting resin include at least one selected from the group consisting of a thermosetting (meth)acrylic resin and a thermosetting polyester resin. Among the thermosetting resins, the thermosetting polyester resin is preferable from the viewpoint of easy control of charging series at the time of performing coating, strength of the coating film, excellent finishing properties, and the like.

Examples of the thermosetting reaction group included in the thermosetting polyester resin include an epoxy group, a carboxyl group, a hydroxyl group, an amide group, an amino group, an acid anhydride group, a block isocyanate group, and the like, and the carboxyl group and the hydroxyl group are preferable from the viewpoint of easy synthesis.

Thermosetting Polyester Resin

The thermosetting polyester resin is a polyester resin having a curable reaction group. Examples of a thermosetting reaction group included in the thermosetting polyester resin include an epoxy group, a carboxyl group, a hydroxyl group, an amide group, an amino group, an acid anhydride group, a block isocyanate group, and the like, and the carboxyl group and the hydroxyl group are preferable from the viewpoint of easy synthesis.

The thermosetting polyester resin, for example, is a polycondensate obtained by performing at least polycondensation with respect to a polybasic acid and polyol.

The thermosetting reaction group of the thermosetting polyester resin is introduced by adjusting the use amount of the polybasic acid and the polyol at the time of synthesizing the polyester resin. According to the adjustment, a thermosetting polyester resin having at least one of a carboxyl group and a hydroxyl group is able to be obtained as the thermosetting reaction group.

In addition, the thermosetting polyester resin may be obtained by introducing the thermosetting reaction group after the polyester resin is synthesized.

Examples of polybasic acid include terephthalic acid, isophthalic acid, phthalic acid, methylterephthalic acid, trimellitic acid, pyromellitic acid, or anhydrides thereof; succinic acid, adipic acid, azelaic acid, sebacic acid, or anhydrides thereof; maleic acid, itaconic acid, or anhydrides thereof; fumaric acid, tetrahydrophthalic acid, methyltetrahydrophthalic acid, hexahydrophthalic acid, methylhexahydrophthalic acid, or anhydrides thereof; cyclohexane dicarboxylic acid, 2,6-naphthalene dicarboxylic acid, and the like.

Examples of polyol include ethylene glycol, diethylene glycol, propylene glycol, dipropylene glycol, 1,3-butanediol, 1,4-butanediol, 1,5-pentanediol, 1,6-hexanediol, neopentyl glycol, triethylene glycol, bis-hydroxyethyl terephthalate, cyclohexanedimethanol, octanediol, diethylpropane diol, butylethylpropane diol, 2-methyl-1,3-propane diol, 2,2,4-trimethylpentane diol, hydrogenated bisphenol A, an ethylene oxide adduct of hydrogenated bisphenol A, a propylene oxide adduct of hydrogenated bisphenol A, trimethylolethane, trimethylolpropane, glycerin, pentaerythritol, tris-hydroxyethyl isocyanurate, hydroxy pivalyl hydroxy pivalate, and the like.

The thermosetting polyester resin may be obtained by polycondensing other monomer in addition to polybasic acid and polyol.

Examples of the other monomer include a compound including both a carboxylic group and a hydroxyl group in one molecule (for example, dimethanol propionic acid and hydroxy pivalate), a monoepoxy compound (for example, glycidyl ester of branched aliphatic carboxylic acid such as “CARDURA E10 (manufactured by Shell)”), various monohydric alcohols (for example, methanol, propanol, butanol, and benzyl alcohol), various monobasic acids (for example, benzoic acid and p-tert-butyl benzoate), various fatty acids (for example, castor oil fatty acid, coconut oil fatty acid, and soybean oil fatty acid), and the like.

The structure of the thermosetting polyester resin may be a branched structure or a linear structure.

Regarding the thermosetting polyester resin, the total of an acid value and a hydroxyl value is preferably from 10 mgKOH/g to 250 mgKOH/g, and the number average molecular weight is preferably from 1,000 to 100,000.

When the total of an acid value and a hydroxyl value is in the range described above, smoothness and a mechanical property of the coating film are easily improved. When the number average molecular weight is in the range described above, smoothness and a mechanical property of the coating film are improved and storage stability of the powder coating material is easily improved.

The measurement of the acid value and the hydroxyl value of the thermosetting polyester resin is performed based on JIS K-0070-1992. In addition, the measurement of the number average molecular weight of the thermosetting polyester resin is performed in the same manner as measurement of the number average molecular weight of the thermosetting (meth)acrylic resin.

Thermosetting (Meth)Acrylic Resin

The thermosetting (meth)acrylic resin is a (meth)acrylic resin including a thermosetting reaction group. For the introduction of the thermosetting reaction group to the thermosetting (meth)acrylic resin, a vinyl monomer including a thermosetting reaction group may preferably be used. The vinyl monomer including a thermosetting reaction group may be a (meth)acrylic monomer (monomer having a (meth)acryloyl group), or may be a vinyl monomer other than the (meth)acrylic monomer.

Examples of the thermosetting reaction group of the thermosetting (meth)acrylic resin include an epoxy group, a carboxylic group, a hydroxyl group, an amide group, an amino group, an acid anhydride group, a (block) isocyanate group, and the like. Among these, as the thermosetting reaction group of the (meth)acrylic resin, at least one kind selected from the group consisting of an epoxy group, a carboxylic group, and a hydroxyl group is preferable, from the viewpoint of ease of preparation of the (meth)acrylic resin. Particularly, from the viewpoints of excellent storage stability of the powder coating material and coating film appearance, at least one kind of the thermosetting reaction group is more preferably an epoxy group.

Examples of the vinyl monomer including an epoxy group as the thermosetting reaction group include various chain epoxy group-containing monomers (for example, glycidyl (meth)acrylate, β-methyl glycidyl (meth)acrylate, glycidyl vinyl ether, and allyl glycidyl ether), various (2-oxo-1,3-oxolane) group-containing vinyl monomers (for example, (2-oxo-1,3-oxolane)methyl (meth)acrylate), various alicyclic epoxy group-containing vinyl monomers (for example, 3,4-epoxy cyclohexyl (meth)acrylate, 3,4-epoxycyclohexylmethyl (meth)acrylate, and 3,4-epoxycyclohexylethyl (meth)acrylate), and the like.

Examples of the vinyl monomer including a carboxylic group as the thermosetting reaction group include various carboxylic group-containing monomers (for example, (meth)acrylic acid, crotonic acid, Itaconic acid, maleic acid, and fumaric acid), various monoesters of α,β-unsaturated dicarboxylic acid and monohydric alcohol having 1 to 18 carbon atoms (for example, monomethyl fumarate, monoethyl fumarate, monobutyl fumarate, monoisobutyl fumarate, monotert-butyl fumarate, monohexyl fumarate, monooctyl fumarate, mono 2-ethylhexyl fumarate, monomethyl maleate, monoethyl maleate, monobutyl maleate, monoisobutyl maleate, monotert-butyl maleate, monohexyl maleate, monooctyl maleate, and mono 2-ethylhexyl maleate), monoalkyl ester itaconate (for example, monomethyl itaconate, monoethyl itaconate, monobutyl itaconate, monoisobutyl itaconate, monohexyl itaconate, monooctyl itaconate, and mono 2-ethylhexyl itaconate), and the like.

Examples of the vinyl monomer including a hydroxyl group as the thermosetting reaction group include various hydroxyl group-containing (meth)acrylates (for example, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, polyethylene glycol mono(meth)acrylate, and polypropylene glycol mono(meth)acrylate), an addition reaction product of the various hydroxyl group-containing (meth)acrylates and ε-caprolactone, various hydroxyl group-containing vinyl ethers (for example, 2-hydroxyethyl vinyl ether, 3-hydroxypropyl vinyl ether, 2-hydroxypropyl vinyl ether, 4-hydroxybutyl vinyl ether, 3-hydroxybutyl vinyl ether, 2-hydroxy-2-methylpropyl vinyl ether, 5-hydroxypentyl vinyl ether, and 6-hydroxyhexyl vinyl ether), an addition reaction product of the various hydroxyl group-containing vinyl ethers and ε-caprolactone, various hydroxyl group-containing allyl ethers (for example, 2-hydroxyethyl (meth)allyl ether, 3-hydroxypropyl (meth)allyl ether, 2-hydroxypropyl (meth)allyl ether, 4-hydroxybutyl (meth)allyl ether, 3-hydroxybutyl (meth)allyl ether, 2-hydroxy-2-methylpropyl (meth)allyl ether, 5-hydroxypentyl (meth)allyl ether, and 6-hydroxyhexyl (meth)allyl ether), an addition reaction product of the various hydroxyl group-containing allyl ethers and ε-caprolactone, and the like.

In the thermosetting (meth)acrylic resin, another vinyl monomer not including a thermosetting reaction group may be copolymerized, in addition to the (meth)acrylic monomer.

Examples of the other vinyl monomer include various α-olefins (for example, ethylene, propylene, and butene-1), various halogenated olefins except fluoroolefin (for example, vinyl chloride and vinylidene chloride), various aromatic vinyl monomers (for example, styrene, α-methyl styrene, and vinyl toluene), various diesters of unsaturated dicarboxylic acid and monohydric alcohol having 1 to 18 carbon atoms (for example, dimethyl fumarate, diethyl fumarate, dibutyl fumarate, dioctyl fumarate, dimethyl maleate, diethyl maleate, dibutyl maleate, dioctyl maleate, dimethyl itaconate, diethyl itaconate, dibutyl itaconate, and dioctyl itaconate), various acid anhydride group-containing monomers (for example, maleic anhydride, itaconic anhydride, citraconic anhydride, (meth)acrylic anhydride, and tetrahydrophthalic anhydride), various phosphoric acid ester group-containing monomers (for example, diethyl-2-(meth)acryloyloxyethyl phosphate, dibutyl-2-(meth)acryloyloxybutyl phosphate, dioctyl-2-(meth)acryloyloxyethyl phosphate, and diphenyl-2-(meth)acryloyloxyethyl phosphate), various hydrolyzable silyl group-containing monomers (for example, γ-(meth)acryloyloxypropyl trimethoxysilane, γ-(meth)acryloyloxypropyl triethoxysilane, and γ-(meth)acryloyloxypropyl methyldimethoxysilane), various vinyl aliphatic carboxylate (for example, vinyl acetate, vinyl propionate, vinyl butyrate, vinyl isobutyrate, vinyl caproate, vinyl caprylate, vinyl caprate, vinyl laurate, branched vinyl aliphatic carboxylate having 9 to 11 carbon atoms, and vinyl stearate), various vinyl ester of carboxylic acid having a cyclic structure (for example, cyclohexane carboxylic acid vinyl, methylcyclohexane carboxylic acid vinyl, vinyl benzoate, and p-tert-butyl vinyl benzoate), and the like.

In the thermosetting (meth)acrylic resin, in the case of using a vinyl monomer other than the (meth)acrylic monomer, as the vinyl monomer including a thermosetting reaction group, an acrylic monomer not including a thermosetting reaction group is used.

Examples of the acrylic monomer not including a thermosetting reaction group include alkyl ester (meth)acrylate (for example, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, cyclohexyl (meth)acrylate, 2-ethylhexyl (meth)acrylate, n-octyl (meth)acrylate, isooctyl (meth)acrylate, 2-ethyloctyl (meth)acrylate, dodecyl (meth)acrylate, isodecyl (meth)acrylate, lauryl (meth)acrylate, and stearyl (meth)acrylate), various aryl ester (meth)acrylates (for example, benzyl (meth)acrylate, phenyl (meth)acrylate, and phenoxyethyl (meth)acrylate), various alkyl carbitol (meth)acrylates (for example, ethyl carbitol (meth)acrylate), other various ester (meth)acrylates (for example, isobornyl (meth)acrylate, dicyclopentanyl (meth)acrylate, dicyclopentenyl (meth)acrylate, dicyclopentenyloxyethyl (meth)acrylate, and tetrahydrofurfuryl (meth)acrylate), various amino group-containing amide unsaturated monomers (for example, N-dimethylaminoethyl (meth)acrylamide, N-diethylaminoethyl (meth)acrylamide, N-dimethylaminopropyl (meth)acrylamide, and N-diethylamino propyl (meth)acrylamide), various dialkylaminoalkyl (meth)acrylates (for example, dimethylaminoethyl (meth)acrylate and diethylaminoethyl (meth)acrylate), various amino group-containing monomers (for example, tert-butylaminoethyl (meth)acrylate, tert-butylaminopropyl (meth)acrylate, aziridinylethyl (meth)acrylate, pyrrolidinylethyl (meth)acrylate, and piperidinylethyl (meth)acrylate), and the like.

The thermosetting (meth)acrylic resin is preferably an acrylic resin having a number average molecular weight of from 1,000 to 20,000 (more preferably from 1,500 to 15,000).

When the number average molecular weight thereof is in the range described above, smoothness and mechanical properties of the coating film are easily improved.

The number average molecular weight of the thermosetting (meth)acrylic resin is measured by gel permeation chromatography (GPC). The molecular weight measurement by GPC is performed with a THF solvent using HLC-8120 GPC, which is GPC manufactured by Tosoh Corporation as a measurement device and TSKGEL SUPER HM-M (15 cm), which is a column manufactured by Tosoh Corporation. The weight average molecular weight and the number average molecular weight are calculated using a calibration curve of molecular weight created with a monodisperse polystyrene standard sample from results of this measurement.

The thermosetting resin may be used alone or in combination of two or more kinds thereof.

The content of the thermosetting resin is preferably from 20% by weight to 99% by weight, and is more preferably from 30% by weight to 95% by weight, with respect to the total content of the powder particles.

Furthermore, as described below, in the case where the powder particles are core-shell particles, when the thermosetting resin is applied as a resin of a resin coating portion, the content of the thermosetting resin described above indicates the content of the total thermosetting resin of a core and the resin coating portion.

Thermosetting Agent

The thermosetting agent is selected according to the type of thermosetting reaction group of the thermosetting resin.

Here, the thermosetting agent indicates a compound having a functional group which is able to react with the thermosetting reaction group which is a terminal group of the thermosetting resin.

When the thermosetting reaction group of the thermosetting resin is a carboxyl group, examples of the thermosetting agent include various epoxy resins (for example, polyglycidyl ether of bisphenol A), an epoxy group-containing acrylic resin (for example, glycidyl group-containing acrylic resin), various polyglycidylethers of polyol (for example, 1,6-hexanediol, trimethylol propane, and trimethylol ethane), various polyglycidyl esters of polycarboxylic acid (for example, phthalic acid, terephthalic acid, isophthalic acid, hexahydrophthalic acid, methyl hexahydrophthalic acid, trimellitic acid, and pyromellitic acid), various alicyclic epoxy group-containing compounds (for example, bis(3,4-epoxy cyclohexyl)methyl adipate), hydroxy amide (for example, triglycidyl isocyanurate and 3-hydroxyalkyl amide), and the like.

When the thermosetting reaction group of the thermosetting resin is a hydroxyl group, examples of the thermosetting agent include blocked polyisocyanate, aminoplast, and the like. Examples of blocked polyisocyanate include organic diisocyanate such as various aliphatic diisocyanates (for example, hexamethylene diisocyanate and trimethyl hexamethylene diisocyanate), various alicyclic diisocyanates (for example, xylylene diisocyanate and isophorone diisocyanate), various aromatic diisocyanates (for example, tolylene diisocyanate and 4,4′-diphenylmethane diisocyanate); an adduct of the organic diisocyanate and polyol, a low-molecular weight polyester resin (for example, polyester polyol), or water; a polymer of the organic diisocyanate (a polymer including isocyanurate-type polyisocyanate compound); various polyisocyanate compounds blocked by a commonly used blocking agent such as isocyanate biuret product; a self-block polyisocyanate compound having a uretdione bond in a structural unit; and the like.

When the thermosetting reaction group of the thermosetting resin is an epoxy group, specific examples of the thermosetting agent include acid such as succinic acid, glutaric acid, adipic acid, pimelic acid, suberic acid, azelaic acid, sebacic acid, dodecanedioic acid, eicosanoic diacid, maleic acid, citraconic acid, itaconic acid, glutaconic acid, phthalic acid, trimellitic acid, pyromellitic acid, tetrahydrophthalic acid, hexahydrophthalic acid, and cyclohexene-1,2-dicarboxylic acid; anhydrides thereof; urethane-modified products thereof; and the like. Among these, as the thermosetting agent, aliphatic dibasic acid is preferably from the viewpoints of a property of the coating film and storage stability, and dodecanedioic acid is particularly preferable from the viewpoint of a property of the coating film.

The thermosetting agent may be used alone or in combination of two or more kinds thereof.

The content of the thermosetting agent is preferably from 1% by weight to 30% by weight and more preferably from 3% by weight to 20% by weight, with respect to the thermosetting resin.

In the case where the powder particle is a particle having a core/shell structure, when the thermosetting resin is used as the resin of the resin coating portion, the content of the thermosetting agent means the content with respect to the entire thermosetting resin in the core and the resin coating portion.

Colorant

As a colorant, a pigment is used, for example. As the colorant, a pigment and a dye may be used in combination.

Examples of a pigment include an inorganic pigment such as iron oxide (for example, colcothar), titanium oxide, titanium yellow, zinc white, white lead, zinc sulfide, lithopone, antimony oxide, cobalt blue, and carbon black; an organic pigment such as quinacridone red, phthalocyanine blue, phthalocyanine green, permanent red, Hansa yellow, indanthrene Blue, Brilliant Fast Scarlet, and benzimidazolone yellow; and the like.

In addition, as the pigment, a brilliant pigment is also used. Examples of the brilliant pigment include metal powder such as a pearl pigment, aluminum powder, stainless steel powder; metallic flakes; glass beads; glass flakes; mica; and flake-shaped iron oxide (MIO).

The colorant may be used alone or in combination of two or more kinds thereof.

The content of the colorant is determined depending on types of the pigment, and the hue, brightness, and the depth required for the coating film.

The content of the colorant is, for example, preferably from 1% by weight to 70% by weight and more preferably from 2% by weight to 60% by weight, with respect to the entire resin which constitutes the powder particle.

Here, the powder particles may contain coloring pigments other than the white pigment as the colorant, along with the white pigment. The powder particles contain the coloring pigment and the white pigment, and thus, the color of the surface of the object to be coated is concealed by the coating film, and color developing properties of the coloring pigment are improved. Furthermore, examples of the white pigment include a known white pigment such as titanium oxide, barium sulphate, zinc oxide, and calcium carbonate, and the titanium oxide is preferable from the viewpoint of high whiteness (that is, high concealing properties).

Metal Ion Having Valence of Two or More

The powder particles may preferably contain a metal ion having a valence of two or more (hereinafter, also simply referred to as “metal ion”). When the powder particles are the core-shell particles as described below, the metal ion may be a component contained in both of the core and the resin coating portion of the powder particles, or either thereof.

When the bivalent or higher valent metal ion is contained in the powder particles, ion-crosslinking is formed due to the metal ion in the powder particles. For example, the ion-crosslinking is formed due to a mutual interaction between the functional group (for example, when the thermosetting polyester resin is used as the thermosetting resin, the carboxyl group or the hydroxyl group of the thermosetting polyester resin) of the thermosetting resin and the metal ion. According to the ion-crosslinking, a phenomenon (so-called bleeding) in which encapsulated substances of the powder particles (the thermosetting agent, and a colorant to be added if necessary, and other additives, in addition to the thermosetting agent) are precipitated on the surface of the powder particles is prevented, and thus, storing properties easily become higher. In addition, in the ion-crosslinking, the bonding of the ion-crosslinking is broken by heating at the time of thermosetting the powder coating material after being coated, and thus, melt viscosity of the powder particles is low, so that a coating film having high smoothness is easily formed and a coating film having increased mechanical strength may be formed.

Examples of the metal ion include a metal ion having a valence of from 2 to 4 (bivalent to tetravalent). Specifically, examples of the metal ion include at least one type of metal ion selected from the group consisting of aluminum ion, magnesium ion, iron ion, zinc ion, and calcium ion.

Examples of a supply source of the metal ion (a compound contained in the powder particles as an additive) include a metal salt, an inorganic metal salt polymer, a metal complex, and the like. When the powder particles are prepared by an aggregation and coalescence method, the metal salt and the inorganic metal salt polymer, for example, are added to the powder particles as a coagulant.

Examples of the metal salt include aluminum sulfate, aluminum chloride, magnesium chloride, magnesium sulfate, iron chloride (II), zinc chloride, calcium chloride, calcium sulfate, and the like.

Examples of the inorganic metal salt polymer include polyaluminum chloride, polyaluminum hydroxide, polyiron sulfate (II), calcium polysulfide, and the like.

Examples of the metal complex include a metal salt of an aminocarboxylic acid, and the like. Specifically, examples of the metal complex include a metal salt (for example, a calcium salt, a magnesium salt, an iron salt, an aluminum salt, and the like) containing a known chelate such as an ethylene diamine tetraacetic acid, a propane diamine tetraacetic acid, a nitrile triacetic acid, a triethylene tetramine hexaacetic acid, and a diethylene triamine pentaacetic acid as a base, and the like.

Furthermore, the supply source of the metal ion may be added not as the coagulant but as a mere additive.

It is preferable that the valence of the metal ion becomes higher from the viewpoint of easily forming mesh-shaped ion-crosslinking, the smoothness and the mechanical strength of the coating film, and the storing properties of the powder coating material. For this reason, Al ion is preferable as the metal ion. That is, an aluminum salt (for example, aluminum sulfate, aluminum chloride, and the like) and an aluminum salt polymer (for example, polyaluminum chloride, polyaluminum hydroxide, and the like) are preferable as the supply source of the metal ion. Further, among the supply sources of the metal ion, an inorganic metal salt polymer is preferable from the viewpoint of the smoothness and the mechanical strength of the coating film, and the storing properties of the powder coating material, compared to the metal salt even at the time of having the same valence of the metal ion. For this reason, the aluminum salt polymer (for example, the polyaluminum chloride, the polyaluminum hydroxide, and the like) is particularly preferable as the supply source of the metal ion.

The content of the metal ion is preferably from 0.002% by weight to 0.2% by weight, and is more preferably from 0.005% by weight to 0.15% by weight, with respect to the total content of the powder particles, from the viewpoint of the smoothness and the mechanical strength of the coating film, and the storing properties of the powder coating material.

When the content of the metal ion is greater than or equal to 0.002% by weight, suitable ion-crosslinking is formed by the metal ion, so that the bleeding of the powder particles is prevented, the storing properties of the coating material easily become higher, and the mechanical strength of the coating film is likely to be increased. On the other hand, when the content of the metal ion is less than or equal to 0.2% by weight, the ion-crosslinking is prevented from being excessively formed by the metal ion, and the smoothness of the coating film easily becomes higher.

Here, when the powder particles are prepared by the aggregation and coalescence method, the supply source of the metal ion (a metal salt and a metal salt polymer) added as the coagulant contributes to control of the particle diameter distribution and the shape of the powder particles.

Specifically, it is preferable that the valence of the metal ion becomes higher from the viewpoint of obtaining a narrow particle diameter distribution. In addition, the metal salt polymer is preferable from the viewpoint of obtaining a narrow particle diameter distribution, compared to the metal salt even at the time of having the same valence of the metal ion. For this reason, from this viewpoint, the aluminum salt (for example, aluminum sulfate, aluminum chloride, and the like) and the aluminum salt polymer (for example, polyaluminum chloride, polyaluminum hydroxide, and the like) are preferable, and the aluminum salt polymer (for example, the polyaluminum chloride, the polyaluminum hydroxide, and the like) is particularly preferable, as the supply source of the metal ion.

In addition, when the coagulant is added such that the content of the metal ion is greater than or equal to 0.002% by weight, aggregation of the resin particles progresses in an aqueous medium, and thus, contributes to realization of a narrow particle diameter distribution. In addition, aggregation of the resin particles which become the resin coating portion progresses with respect to aggregated particles which become the core, and thus, contributes to realization of formation of the coating portion with respect to the entire surface of the core. On the other hand, when the coagulant is added such that the content of the metal ion is less than or equal to 0.2% by weight, the ion-crosslinking is prevented from being excessively formed in the aggregated particles, and the shape of the powder particles to be formed is easily close to a spherical shape at the time of performing aggregation and coalescence. For this reason, from the viewpoint, the content of the metal ion is preferably from 0.002% by weight to 0.2% by weight, and is more preferably from 0.005% by weight to 0.15% by weight.

The content of the metal ion is measured by performing quantitative analysis with respect to intensity of a fluorescent X ray of the powder particles. Specifically, for example, first, the resin and the supply source of the metal ion are mixed, and thus, a resin mixture in which the concentration of the metal ion is already known. A pellet sample is obtained from 200 mg of the resin mixture by using a tablet molding machine having a diameter of 13 mm. The weight of the pellet sample is weighed, intensity of a fluorescent X ray of the pellet sample is measured, and thus, peak intensity is obtained. Similarly, a pellet sample in which the added amount of the supply source of the metal ion is changed is also subjected to measurement, and a calibration curve is prepared from the result thereof. Then, the content of the metal ion in the powder particles which become a measurement target is subjected to quantitative analysis by using the calibration curve.

Examples of an adjustment method of the content of the metal ion include 1) a method of adjusting the added amount of the supply source of the metal ion, 2) a method of adjusting the content of the metal ion by adding the coagulant (for example the metal salt or the metal salt polymer) as the supply source of the metal ion in an aggregation step at the time of preparing the powder particles by the aggregation and coalescence method, and then by adding a chelating agent (for example, an ethylene diamine tetraacetic acid (EDTA), a diethylene triamine pentaacetic acid (DTPA), a nitrilotriacetic acid (NTA), and the like) in the final stage of the aggregation step, by forming a complex with the metal ion by the chelating agent, and by removing a complex salt which is formed in the subsequent washing step or the like, and the like.

Other Additive

As the other additive, various additives used in the powder coating material are used.

Specific examples of the other additive include a foam inhibitor (for example, benzoin or benzoin derivatives), a hardening accelerator (an amine compound, an imidazole compound, or a cationic polymerization catalyst), a surface adjusting agent (a leveling agent), a plasticizer, a charge-controlling agent, an antioxidant, a pigment dispersant, a flame retardant, a fluidity-imparting agent, and the like.

Core-Shell Particles

In this exemplary embodiment, the powder particles may be the core-shell particles including the core which contains the thermosetting resin and the thermosetting agent, and the resin coating portion which covers the surface of the core.

At this time, the core may contain the additives other than the colorant described above, if necessary, in addition to the thermosetting resin and the thermosetting agent.

In addition, the resin coating portion of the core-shell particles will be described below.

The resin coating portion may be composed only of a resin, or may contain other components (the thermosetting agent, the other additives, and the like which are described as the components constituting the core).

Here, it is preferable that the resin coating portion is composed only of the resin from the viewpoint of reducing the bleeding. Furthermore, even when the resin coating portion contains other components in addition to the resin, the content of the resin may be greater than or equal to 90% by weight (preferably, greater than or equal to 95% by weight) with respect to the total resin coating portion.

The resin constituting the resin coating portion may be a non-curable resin, or may be a thermosetting resin, and it is preferable that the resin is the thermosetting resin from the viewpoint of improving curing density (crosslinking density) of the coating film.

When the thermosetting resin is applied as the resin of the resin coating portion, examples of the thermosetting resin include the same thermosetting resins as those of the core, and preferable examples thereof are identical to those of the thermosetting resin of the core. Here, the thermosetting resin of the resin coating portion may be a resin identical to the thermosetting resin of the core, or may be a resin different from the thermosetting resin of the core.

Furthermore, when the non-curable resin is applied as the resin of the resin coating portion, examples of the non-curable resin preferably include at least one selected from the group consisting of an acrylic resin and a polyester resin.

A coverage of the resin coating portion is preferably from 30% to 100% and more preferably from 50% to 100%, in order to prevent bleeding.

The coverage of the resin coating portion with respect to the surface of the powder particle is a value determined by X-ray photoelectron spectroscopy (XPS) measurement.

Specifically, in the XPS measurement, JPS-9000MX manufactured by JEOL Ltd. is used as a measurement device, and the measurement is performed using a MgKα ray as the X-ray source and setting an accelerating voltage to 10 kV and an emission current to 30 mA.

The coverage of the resin coating portion with respect to the surface of the powder particles is quantized by peak separation of a component derived from the material of the core and a component derived from a material of the resin coating portion on the surface of the powder particles, from the spectrum obtained under the conditions described above. In the peak separation, the measured spectrum is separated into each component using curve fitted by the least square method.

As the component spectrum to be a separation base, the spectrum obtained by singly measuring the thermosetting resin, a thermosetting agent, a pigment, an additive, a coating resin used in preparation of the powder particle is used. In addition, the coverage is determined from a ratio of a spectral intensity derived from the coating resin with respect to the total of entire spectral intensity obtained from the powder particles.

A thickness of the resin coating portion is preferably from 0.2 μm to 4 μm and more preferably from 0.3 μm to 3 μm, in order to prevent bleeding.

The thickness of the resin coating portion is a value measured by the following method. The powder particle is embedded in the epoxy resin or the like, and a sliced piece is prepared by performing cutting with a diamond knife. This sliced piece is observed using a transmission electron microscope (TEM) or the like and plural images of the cross section of the powder particles are imaged. The thicknesses of 20 portions of the resin coating portion are measured from the images of the cross section of the powder particle, and an average value thereof is used. When it is difficult to observe the resin coating portion in the image of the cross section due to a clear powder coating material, it is possible to easily perform the measurement by performing dyeing and observation.

Preferable Properties of Powder Particles

Volume Particle Diameter Distribution Index GSDv

The volume particle diameter distribution index GSDv of the powder particles is preferably less than or equal to 1.50, is more preferably less than or equal to 1.40, and is even more preferably less than or equal to 1.30, from the viewpoint of the smoothness of the coating film and the storing properties of the powder coating material. In particular, it is preferable that the volume particle diameter distribution index GSDv of the powder particles (that is, the volume particle diameter distribution index GSDv of the powder particles before being sprayed) is less than or equal to 1.40, from the viewpoint of setting the average circularity Sc of the attached powder particles and the average circularity So of the powder particles before being sprayed to satisfy the relationship of the expression described above.

Volume Average Particle Diameter D50v

In addition, a volume average particle diameter D50v of the powder particles is preferably from 1 μm to 25 μm, is more preferably from 2 μm to 20 μm, and is even more preferably from 3 μm to 15 μm, from the viewpoint of forming a coating film having high smoothness with a small amount thereof. In particular, the volume average particle diameter D50v of the powder particles (that is, the volume average particle diameter Do of the powder particles before being sprayed) is preferably from 3 μm to 20 μm, and is more preferably from 3 μm to 10 μm, from the viewpoint of setting the average circularity Sc of the attached powder particles and the average circularity So of the powder particles before being sprayed to satisfy the relationship of the expression described above.

Herein, the volume average particle diameter D50v and the volume particle diameter distribution index GSDv of the powder particles are measured with a COULTER MULTISIZER II (manufactured by Beckman Coulter, Inc.) and ISOTON-II (manufactured by Beckman Coulter, Inc.) as an electrolyte.

In the measurement, from 0.5 mg to 50 mg of a measurement sample is added to 2 ml of a 5% aqueous solution of surfactant (preferably sodium alkyl benzene sulfonate) as a dispersing agent. The obtained material is added to 100 ml to 150 ml of the electrolyte.

The electrolyte in which the sample is suspended is subjected to a dispersion treatment using an ultrasonic disperser for 1 minute, and a particle size distribution of particles having a particle diameter of 2 μm to 60 μm is measured by a Coulter Multisizer II using an aperture having an aperture diameter of 100 μm. 50,000 particles are sampled.

Cumulative distributions by volume are drawn from the side of the smallest diameter with respect to particle size ranges (channels) separated based on the measured particle size distribution. The particle diameter when the cumulative percentage becomes 16% is defined as that corresponding to a volume average particle diameter D16v, while the particle diameter when the cumulative percentage becomes 50% is defined as that corresponding to a volume average particle diameter D50v. Furthermore, the particle diameter when the cumulative percentage becomes 84% is defined as that corresponding to a volume average particle diameter D84v.

A volume particle diameter distribution index (GSDv) is calculated as (D84v/D16v)^{1/2}.

External Additive

Since an external additive prevents occurrence of aggregation between the powder particles, it is possible to form a coating film having high smoothness with a small amount thereof. Specific examples of the external additive include inorganic particles. Examples of the inorganic particles include particles of SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄, and silica particles may be preferably used as the external additive.

Surfaces of the inorganic particles as an external additive are preferably subjected to a hydrophobizing treatment. The hydrophobizing treatment is performed by, for example, dipping the inorganic particles in a hydrophobizing agent. The hydrophobizing agent is not particularly limited and examples thereof include a silane coupling agent, silicone oil, a titanate coupling agent, and an aluminum coupling agent. These may be used alone or in combination of two or more kinds thereof.

Generally, the amount of the hydrophobizing agent is, for example, from 1 part by weight to 10 parts by weight with respect to 100 parts by weight of the inorganic particles.

The volume average particle diameter of the external additive is preferably from 5 nm to 200 nm, is more preferably from 7 nm to 100 nm, and is even more preferably from 10 nm to 50 nm. When the volume average particle diameter of the external additive is from 5 nm to 200 nm, the powder particles are dispersed in the air flow and are easily flown as primary particles at the time of performing coating of the powder coating material by using an electrostatic powder coating machine, and thus, the powder particles are attached to the object to be coated in a state of the primary particles, color arrangement (toning) in the particle diameter unit is easily performed, and toning properties become excellent.

In addition, by adding the same type of external additive to powder particles of plural powder coating materials having colors different from each other, a difference in charging properties between the powder coating materials is reduced. For this reason, when different powder coating materials are mixed (toned), mixing properties become higher, and the occurrence of color unevenness is further prevented.

The amount of the external additive externally added is, for example, preferably from 0.01% by weight to 5% by weight and more preferably from 0.01% by weight to 2.0% by weight, with respect to the powder particles.

Method of Preparing Powder Coating Material

Next, a method of preparing the powder coating material according to the exemplary embodiment will be described.

After preparing the powder particles, the powder coating material according to the exemplary embodiment is obtained by externally adding the external additives to the powder particles, if necessary.

The powder particles may be prepared using any of a dry preparing method (e.g., kneading and pulverization method) and a wet preparing method (e.g., aggregation and coalescence method, suspension and polymerization method, and dissolution and suspension method). The powder particle preparing method is not particularly limited to these preparing methods, and a known preparing method is employed.

For example, examples of the dry preparing method include 1) a kneading and pulverizing method in which the thermosetting resin and other raw materials are kneaded, pulverized, and classified, a dry preparing method in which the shape of the particles obtained by the kneading and pulverizing method is changed by a mechanical impact force or thermal energy, and the like.

On the other hand, example of the wet preparing method include 1) an aggregation and coalescence method in which a dispersion obtained by performing emulsion polymerization with respect to a polymerizable monomer for obtaining the thermosetting resin and a dispersion of the other raw materials are mixed, aggregated, and heated and coalesced, and thus, the powder particles are obtained, 2) a suspension and polymerization method in which the polymerizable monomer for obtaining the thermosetting resin and a solution of the other raw materials are suspended and polymerized in an aqueous solvent, 3) a dissolution and suspension method in which the thermosetting resin and the solution of the other raw materials are suspended and granulated in the aqueous solvent, and the like. Furthermore, the wet preparing method is able to be preferably used from the viewpoint of a small thermal influence.

In addition, the powder particles being the core-shell particles may be obtained by attaching resin particles to the powder particles obtained by the preparing method described above, which are used as a core, followed by heating and coalescing.

Among them, it is preferable that the powder particles are obtained by the aggregation and coalescence method, from the viewpoint of enabling the volume particle diameter distribution index GSDv, the volume average particle diameter D50v, and the average circularity to be easily controlled such that the volume particle diameter distribution index GSDv, the volume average particle diameter D50v, and the average circularity are in the preferable range described above.

Hereinafter, the aggregation and coalescence method of preparing the powder particles which are the core-shell particles will be described as an example.

Specifically, it is preferable that the powder particles are prepared through a step of forming first aggregated particles (a first aggregated particle forming step) by aggregating first resin particles containing a thermosetting resin, and a thermosetting agent in a dispersion in which the first resin particles and the thermosetting agent are dispersed or by aggregating composite particles in a dispersion in which composite particles containing a thermosetting resin and a thermosetting agent are dispersed, a step of forming second aggregated particles (a second aggregated particle forming step) by mixing a first aggregated particle dispersion in which the first aggregated particles are dispersed and a second resin particle dispersion in which second resin particles containing a resin are dispersed, by aggregating the second resin particles on the surface of the first aggregated particles, and by attaching the second resin particles onto the surface of the first aggregated particles, and a step of coalescing the second aggregated particles (a coalescence step) by heating a second aggregated particle dispersion in which the second aggregated particles are dispersed.

Furthermore, in the powder particles prepared by the aggregation and coalescence method, a portion in which the first aggregated particles are coalesced becomes the core, and a portion in which the second resin particles attached onto the surface of the first aggregated particles are coalesced becomes the resin coating portion.

For this reason, powder particles having a single layer structure are able to be obtained insofar as the first aggregated particles formed in the first aggregated particle forming step are supplied to the coalescence step not through the second aggregated particle forming step, and are coalesced instead of the second aggregated particles.

Hereinafter, the details of each of the steps will be described.

Furthermore, in the following description, a preparing method of powder particles containing a colorant will be described, but the colorant is contained, if necessary.

Preparing Step of Each Dispersion

First, each dispersion which is used in the aggregation and coalescence method is prepared.

Specifically, the first resin particle dispersion in which the first resin particles containing the thermosetting resin of the core are dispersed, a thermosetting agent dispersion in which the thermosetting agent is dispersed, a colorant dispersion in which the colorant is dispersed, and the second resin particle dispersion in which the second resin particles containing the resin of the resin coating portion are dispersed are prepared.

In addition, a composite particle dispersion, in which composite particles containing a thermosetting resin for a core and a thermosetting agent are dispersed, is prepared instead of the first resin particle dispersion and the thermosetting agent dispersion.

Furthermore, in each of the steps of the preparing method of the powder coating material, the first resin particles, the second resin particles, and the composite particles will be described by being collectively referred to as “resin particles”, and a dispersion of the resin particles will be described by being referred to as a “resin particle dispersion”.

Herein, a resin particle dispersion is, for example, prepared by dispersing the resin particles in a dispersion medium with a surfactant.

An aqueous medium is used, for example, as the dispersion medium used in the resin particle dispersion.

Examples of the aqueous medium include water such as distilled water, ion exchange water, or the like, alcohols, and the like. The medium may be used alone or in combination of two or more kinds thereof.

Examples of the surfactant include anionic surfactants such as sulfuric ester salt, sulfonate, phosphate ester, and soap anionic surfactants; cationic surfactants such as amine salt and quaternary ammonium salt cationic surfactants; and nonionic surfactants such as polyethylene glycol, alkyl phenol ethylene oxide adduct, and polyol nonionic surfactants. Among these, anionic surfactants and cationic surfactants are particularly used. Nonionic surfactants may be used in combination with anionic surfactants or cationic surfactants.

The surfactants may be used alone or in combination of two or more kinds thereof.

Regarding the resin particle dispersion, as a method of dispersing the resin particles in the dispersion medium, a common dispersing method using, for example, a rotary shearing-type homogenizer, or a ball mill, a sand mill, or a Dyno mill having media is exemplified. Depending on the kind of the resin particles, the resin particles may be dispersed in the resin particle dispersion using, for example, a phase inversion emulsification method.

The phase inversion emulsification method includes: dissolving a resin to be dispersed in a hydrophobic organic solvent in which the resin is soluble; conducting neutralization by adding a base to an organic continuous phase (O phase); and converting the resin (so-called phase inversion) from W/O to O/W by adding an aqueous medium (W phase) to form a discontinuous phase, thereby dispersing the resin as particles in the aqueous medium.

Specifically, examples of a preparation method of the resin particle dispersion include the following methods.

For example, when the resin particle dispersion is a polyester resin particle dispersion in which polyester resin particles are dispersed, such a polyester resin particle dispersion is able to be obtained by heating and melting a raw material monomer and by polycondensing the raw material monomer under reduced pressure, and then by adding the obtained polycondensate to a solvent (for example, ethyl acetate) and by dissolving the polycondensate in the solvent, by stirring the obtained dissolved material while adding a weak alkaline aqueous solution thereto, and by performing phase inversion and emulsion with respect to the dissolved material.

Furthermore, when the resin particle dispersion is the composite particle dispersion, the composite particle dispersion is able to be obtained by mixing the thermosetting resin and the thermosetting agent, followed by dispersing in a dispersion medium (for example, performing emulsification such as phase inversion and emulsion).

The volume average particle diameter of the resin particles dispersed in the resin particle dispersion is, for example, preferably equal to or smaller than 1 μm, more preferably from 0.01 μm to 1 μm, even more preferably from 0.08 m to 0.8 μm, and still more preferably from 0.1 μm to 0.6 μm.

Regarding the volume average particle diameter of the resin particles, a cumulative distribution by volume is drawn from the side of the smallest diameter with respect to particle size ranges (channels) separated using the particle size distribution obtained by the measurement with a laser diffraction-type particle size distribution measuring device (for example, LA-700 manufactured by Horiba, Ltd.), and a particle diameter when the cumulative percentage becomes 50% with respect to the entire particles is measured as a volume average particle diameter D50v. The volume average particle diameter of the particles in other dispersions is also measured in the same manner.

Here, in order to prepare the resin particle dispersion, a known emulsion method is able to be used, and a phase inversion and emulsion method is effective in which a particle diameter distribution to be obtained is narrow, and a volume average particle diameter is easily in a range of less than or equal to 1 μm (in particular, from 0.08 μm to 0.40 μm).

In the phase inversion and emulsion method, the resin is dissolved in an organic solvent dissolving the resin, and an independent amphiphilic organic solvent or a mixed solvent, and thus, is in an oil phase. A small amount of basic compound is dropped while stirring the oil phase, water is slightly dropped while further stirring the oil phase, and thus, a water droplet is incorporated in the oil phase. Next, when the dropping amount of water is greater than a certain amount, the oil phase and the water phase are inverted, and thus, the oil phase becomes an oil droplet. After that, a water dispersion is able to be obtained through a desolvation step of depressurization.

The amphiphilic organic solvent indicates a solvent having solubility with respect to water at 20° C. is at least greater than or equal to 5 g/L, and is preferably greater than or equal to 10 g/L. When the solubility is less than 5 g/L, an effect of accelerating the speed of an aqueous treatment deteriorates, and storage stability of a water dispersion to be obtained also deteriorates. In addition, examples of the amphiphilic organic solvent include alcohols such as ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol, ketones such as methyl ethyl ketone, methyl isobutyl ketone, ethyl butyl ketone, cyclohexanone, and isophorone, ethers such as tetrahydrofuran and dioxane, esters such as ethyl acetate, n-propyl acetate, isopropyl acetate, n-butyl acetate, isobutyl acetate, sec-butyl acetate, 3-methoxy butyl acetate, methyl propionate, ethyl propionate, diethyl carbonate, and dimethyl carbonate, glycol derivatives such as ethylene glycol, ethylene glycol monomethyl ether, ethylene glycol monoethyl ether, ethylene glycol monopropyl ether, ethylene glycol monobutyl ether, ethylene glycol ethyl ether acetate, diethylene glycol, diethylene glycol monomethyl ether, diethylene glycol monoethyl ether, diethylene glycol monopropyl ether, diethylene glycol monobutyl ether, diethylene glycol ethyl ether acetate, propylene glycol, propylene glycol monomethyl ether, propylene glycol monopropyl ether, propylene glycol monobutyl ether, propylene glycol methyl ether acetate, and dipropylene glycol monobutyl ether, 3-methoxy-3-methyl butanol, 3-methoxy butanol, acetonitrile, dimethyl formamide, dimethyl acetoamide, diacetone alcohol, acetoethyl acetate, and the like. The solvent is able to be independently used, or two or more types thereof are able to be used by being mixed.

Furthermore, the thermosetting polyester resin as the thermosetting resin is neutralized by a basic compound at the time of being dispersed in a water medium. A neutralization reaction with respect to the carboxyl group of the thermosetting polyester resin is an aqueous starting force, and the coalescence between the particles is easily prevented by an electricity repellent force between the generated carboxyl anions.

Examples of the basic compound include ammonia, an organic amine compound having a boiling point of lower than or equal to 250° C., and the like. Preferable examples of the organic amine compound include triethyl amine, N,N-diethyl ethanol amine, N,N-dimethyl ethanol amine, aminoethanol amine, N-methyl-N,N-diethanol amine, isopropyl amine, iminobispropyl amine, ethyl amine, diethyl amine, 3-ethoxy propyl amine, 3-diethyl aminopropyl amine, sec-butyl amine, propyl amine, methyl aminopropyl amine, dimethyl aminopropyl amine, methyl iminobispropyl amine, 3-methoxy propyl amine, monoethanol amine, diethanol amine, triethanol amine, morpholine, N-methyl morpholine, N-ethyl morpholine, and the like.

The basic compound is added in the amount in which the basic compound is able to be at least partially neutralized according to the carboxyl group included in the thermosetting polyester resin, that is, the basic compound is preferably added in the amount of 0.2 times to 9.0 times equivalent to the carboxyl group, and is more preferably added in the amount of 0.6 times to 2.0 times equivalent to the carboxyl group. When the basic compound is added in the amount of greater than or equal to 0.2 times equivalent to the carboxyl group, an effect of adding the basic compound is easily confirmed. When the basic compound is added in the amount of less than or equal to 9.0 times equivalent to the carboxyl group, the particle diameter distribution hardly widens and an excellent dispersion is able to be easily obtained, and it is considered that this is because hydrophilicity of the oil phase is prevented from excessively increasing.

The content of the resin particles contained in the resin particle dispersion is, for example, preferably from 5% by weight to 50% by weight, and more preferably from 10% by weight to 40% by weight.

For example, the thermosetting agent dispersion and the colorant dispersion are also prepared in the same manner as in the case of the resin particle dispersion. That is, the volume average particle diameter, the dispersion medium, the dispersing method, and the content of the particles of the colorant dispersed in the colorant dispersion and the particles of the thermosetting agent dispersed in the thermosetting agent dispersion are the same as those of the resin particles in the resin particle dispersion.

First Aggregated Particle Forming Step

Next, the first resin particle dispersion, the thermosetting agent dispersion, and the colorant dispersion are mixed with each other.

The first resin particles, the thermosetting agent, and the colorant are heterogeneously aggregated in the mixed dispersion, thereby forming first aggregated particles having a diameter near a target powder particle diameter and including the first resin particles, the thermosetting agent, and the colorant.

Specifically, for example, an aggregating agent is added to the mixed dispersion and a pH of the mixed dispersion is adjusted to be acidic (for example, the pH is from 2 to 5). If necessary, a dispersion stabilizer is added. Then, the mixed dispersion is heated at a temperature of a glass transition temperature of the first resin particles (specifically, for example, from a temperature 30° C. lower than the glass transition temperature of the first resin particles to a temperature 10° C. lower than the glass transition temperature thereof) to aggregate the particles dispersed in the mixed dispersion, thereby forming the first aggregated particles.

In the first aggregated particle forming step, the first aggregated particles may be formed by mixing the composite particle dispersion including the thermosetting resin and the thermosetting agent, and the colorant dispersion with each other and heterogeneously aggregating the composite particles and the colorant in the mixed dispersion.

In the first aggregated particle forming step, for example, the aggregating agent may be added at room temperature (for example, 25° C.) while stirring of the mixed dispersion using a rotary shearing-type homogenizer, the pH of the mixed dispersion may be adjusted to be acidic (for example, the pH is from 2 to 5), a dispersion stabilizer may be added if necessary, and the heating may then be performed.

Examples of the aggregating agent include a surfactant having an opposite polarity to the polarity of the surfactant used as the dispersing agent to be added to the mixed dispersion, metal salt, a metal salt polymer, and a metal complex. When a metal complex is used as the aggregating agent, the amount of the surfactant used is reduced and charging characteristics are improved.

After completing the coalescence, an additive for forming a complex or a similar bond with metal ion of the aggregating agent may be used, if necessary. A chelating agent is suitably used as this additive. With the addition of this chelating agent, the content of the metal ion of the powder particles may be adjusted, when the aggregating agent is excessively added.

Herein, the metal salt, the metal salt polymer, or the metal complex as the aggregating agent is used as a supply source of the metal ions. These examples are as described above.

A water-soluble chelating agent is used as the chelating agent. Specific examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added is, for example, preferably from 0.01 parts by weight to 5.0 parts by weight, and more preferably from 0.1 parts by weight to less than 3.0 parts by weight with respect to 100 parts by weight of the resin particles.

Second Aggregated Particle Forming Step

Next, the obtained first aggregated particle dispersion in which the first aggregated particles are dispersed is mixed together with the second resin particle dispersion.

The second resin particles may be the same kind as the first resin particles or may be an irregular kind therefrom.

Aggregation is performed such that the second resin particles are attached to the surface of the first aggregated particles in the mixed dispersion in which the first aggregated particles and the second resin particles are dispersed, thereby forming second aggregated particles in which the second resin particles are attached to the surface of the first aggregated particles.

Specifically, in the first aggregated particle forming step, for example, when the particle diameter of the first aggregated particles reaches a target particle diameter, the second resin particle dispersion is mixed with the first aggregated particle dispersion, and the mixed dispersion is heated at a temperature equal to or lower than the glass transition temperature of the second resin particles.

By setting pH of the mixed dispersion to be in a range of 6.5 to 8.5, for example, the progress of the coalescence is stopped.

Accordingly, the second aggregated particles aggregated in such a way that the second resin particles are attached to the surface of the first aggregated particles are obtained.

Coalescence Step

Next, the second aggregated particle dispersion in which the second aggregated particles are dispersed is heated at, for example, a temperature that is equal to or higher than the glass transition temperature of the first and second resin particles (for example, a temperature that is higher than the glass transition temperature of the first and second resin particles by 10° C. to 30° C.) to coalesce the second aggregated particles and form the powder particles.

The powder particles are obtained through the foregoing step.

Herein, after the coalescence step ends, the powder particles formed in the dispersion are subjected to a washing step, a solid-liquid separation step, and a drying step, that are well known, and thus, dry powder particles are obtained.

In the washing step, preferably displacement washing using ion exchange water is sufficiently performed from the viewpoint of charging properties. In addition, the solid-liquid separation step is not particularly limited, but suction filtration, pressure filtration, or the like is preferably performed from the viewpoint of productivity. The method for the drying step is also not particularly limited, but freeze drying, airflow drying, fluidized drying, vibration-type fluidized drying, or the like is preferably performed from the viewpoint of productivity.

The powder coating material according to the exemplary embodiment is prepared by adding and mixing, for example, an external additive to the obtained dry powder particles, if necessary.

The mixing is preferably performed with, for example, a V-blender, a Henschel mixer, a Lödige mixer, or the like.

Furthermore, if necessary, coarse particles of the powder particle may be removed using a vibration sieving machine, a wind classifier, or the like.

### Examples

Hereinafter, this exemplary embodiment will be described in detail with reference to examples, and this exemplary embodiment is not limited to the examples. Furthermore, in the following description, unless otherwise particularly stated, both of “parts” and “%” are based on the weight.

Polyester Resin Clear Powder Coating Material (PCC Type)

Preparation of Polyester Resin and Curing Agent Composite Dispersion (E1)

A mixed solvent of 180 parts by weight of ethyl acetate and 80 parts by weight of isopropyl alcohol is put into a 3L-reaction vessel with a jacket (BJ-30N, manufactured by TOKYO RIKAKIKAI CO, LTD.), which is provided with a condenser, a thermometer, a water dropping device and an anchor blade, while maintaining the reaction vessel in a water circulation type thermostatic bath at 40° C., and the following components are charged thereinto.
Polyester Resin (PES1) [Polycondensate of Terephthalic Acid/Ethylene Glycol/Neopentyl Glycol/Trimethylol Propane (Molar Ratio=100/60/38/2 (mol %), Glass Transition Temperature=62° C., Acid Value (Av)=12 mgKOH/g, Hydroxyl Value (OHv)=55 mgKOH/g, Weight Average Molecular Weight (Mw)=12,000, and Number Average Molecular Weight (Mn)=4,000]: 240 parts by weight
Blocked Isocyanate Curing Agent VESTAGON B 1530 (manufactured by Evonik Japan Co., Ltd.): 60 parts by weight
Benzoin: 1.5 parts by weight
Acrylic Oligomer (ACRONAL 4F, manufactured by BASF SE): 3 parts by weight

After the above components are charged thereinto, the resultant is stirred at 150 rpm using a three-one motor to perform dissolution, thereby preparing an oil phase. A mixed liquid of 1 part by weight of a 10% ammonia aqueous solution by weight and 47 parts by weight of a 5% aqueous solution of sodium hydroxide by weight is dropped into the oil phase being stirred, over 5 minutes and is mixed for 10 minutes, and then, 900 parts by weight of ion exchange water is further dropped thereinto at a rate of 5 parts by weight per a minute, and thus, a phase inversion is performed to thereby obtain an emulsion liquid.

Immediately, 800 parts by weight of the obtained emulsion liquid and 700 parts by weight of ion exchange water are put into an eggplant 2L-flask, are set in an evaporator provided with a vacuum control unit (manufactured by TOKYO RIKAKIKAI CO, LTD.) through a trap bulb. The eggplant flask is heated in a hot water bath at 60° C. while being rotated, and a solvent is removed by reducing the pressure to 7 kPa while being careful of bumping. When the collected amount of the solvent becomes 1100 parts by weight, the pressure returns to the normal pressure, and the eggplant flask is cooled, and thus, a dispersion is obtained. There is no solvent odor in the obtained dispersion. The volume average particle of resin particles in the dispersion is 145 nm. After that, 2% by weight of an anionic surfactant (DOWFAX2A1, manufactured by The Dow Chemical Company, Amount of Effective Component: 45% by weight) is added and mixed to the resin of the dispersion as an effective component, and adjustment is performed such that a solid concentration becomes 25% by weight by adding ion exchange water thereto. This is designated as a polyester resin and curing agent composite dispersion (E1).

Preparation of Clear Powder Particles (PCC1 Type) Aggregation Step
Polyester Resin and Curing Agent Composite Dispersion (E1): 180 parts by weight (Solid content of 45 parts by weight)
Ion Exchange Water: 200 parts by weight

The components described above are sufficiently mixed and dispersed in a round stainless steel flask by using a homogenizer (ULTRA-TURRAX T50, manufactured by TKA Works GmbH & Co.). Next, the pH is adjusted to be 3.5 by using a 1.0% aqueous solution of a nitric acid. 0.50 parts by weight of a 10% aqueous solution containing polyaluminum chloride is added thereto, and a dispersing operation is continuously performed by using ULTRA-TURRAX.

A stirrer and a mantle heater are disposed, the temperature is increased to up to 50° C. while suitably adjusting the number of rotations of the stirrer such that slurry is sufficiently stirred, the slurry is held at 50° C. for 15 minutes, and then the particle diameter of aggregated particles is measured by using [TA-II] type Coulter Counter (manufactured by Beckman Coulter, Inc., Aperture Diameter: 50 μm), and when the volume average particle diameter becomes 5.5 μm, 60 parts by weight of the polyester resin and curing agent composite dispersion (E1) is slowly put into the flask as a shell (the shell is put into the flask).

Coalescence Step

The flask is held for 30 minutes after the polyester resin and curing agent composite dispersion (E1) thereinto, and then, pH is set to 7.0 by using a 5% aqueous solution of sodium hydroxide. After that, the temperature is increased to up to 85° C. and is held for 1 hour (PCC1-1) or 2 hours (PCC1-2).

Filtering, Washing, and Drying Step

After the reaction ends, a solution in the flask is cooled and is filtered, and thus, a solid is obtained. Next, the solid is sufficiently washed with ion exchange water, and then, solid liquid separation is performed by Nutsche type suction filtration, and thus, a solid is obtained again.

Next, the solid is dispersed again in 3 liters of ion exchange water at 40° C., and is stirred and washed at 300 rpm for 15 minutes. The washing operation is repeated 5 times, the solid obtained by performing the solid liquid separation according to the Nutsche type suction filtration is subjected to vacuum drying for 12 hours, and thus, clear powder particles (PCC1-1 and PCC1-2) are obtained.

When the particle diameter of the clear powder coating material particles is measured, with respect to the clear powder particles PCC1-1, the volume average particle diameter D50v is 6.3 μm, the volume particle diameter distribution index GSDv is 1.26, and the average circularity is 0.949, and with respect to the clear powder particles PCC1-2, the volume average particle diameter D50v is 6.1 μm, the volume particle diameter distribution index GSDv is 1.24, and the average circularity is 0.980.

Preparation of Polyester Resin Clear Powder Coating Materials (PCC1-1 and PCC1-2)

100 parts by weight of the clear powder particles (PCC1-1) and 0.5 parts by weight of hydrophobic silica particles having a volume average particle diameter of 12 nm (R974, manufactured by NIPPON AEROSIL CO., LTD.) are mixed by using a Henschel mixer at a peripheral speed of 32 m/s for 10 minutes, and then coarse particles are removed by using a sieve having a mesh size of 45 μm, and thus, a polyester resin clear powder coating material (PCC1-1) is obtained. In the same manner except for using the clear powder particles (PCC1-2) in place of the clear powder particles (PCC1-1), a polyester resin clear powder coating material (PCC1-2) is obtained.

Polyester Resin Clear Powder Coating Material (PCC2 Type)

Clear powder particles (PCC2-1 and PCC2-2) are obtained by the same method as that of the clear powder particles (PCC1-1 and PCC1-2) except that when the volume average particle diameter of the aggregated particles becomes 8.5 μm in the aggregation step of the preparation of the clear powder particles (PCC1 type), 60 parts by weight of the polyester resin and curing agent composite dispersion (E1) is slowly put into the flask as the shell. Then, polyester resin clear powder coating materials (PCC2-1 and PCC2-2) are obtained by the same method as that of the polyester resin clear powder coating material (PCC1 type) except that the clear powder particles (PCC2 type) are used.

Furthermore, the volume average particle diameter D50v of the clear powder coating material particles PCC2-1 is 9 μm, the volume particle diameter distribution index GSDv is 1.29, and the average circularity is 0.942. The volume average particle diameter D50v of the clear powder particles PCC2-2 is 9.2 μm, the volume particle diameter distribution index GSDv is 1.25, and the average circularity is 0.980.

Polyester Resin Clear Powder Coating Material (PCC3 Type)

Clear powder particles (PCC3-1 and PCC3-2) are obtained by the same method as that of the clear powder particles (PCC1-1 and PCC1-2) except that when the volume average particle diameter of the aggregated particles becomes 3.3 μm in the aggregation step of the preparation of the clear powder particles (PCC1 type), 60 parts by weight of the polyester resin and curing agent composite dispersion (E1) is slowly put into the flask as the shell. Then, polyester resin clear powder coating materials (PCC3-1 and PCC3-2) are obtained by the same method as that of the polyester resin clear powder coating material (PCC1 type) except that the clear powder particles (PCC3 type) are used.

Furthermore, the volume average particle diameter D50v of the clear powder coating material particles PCC3-1 is 4 μm, the volume particle diameter distribution index GSDv is 1.24, and the average circularity is 0.950. The volume average particle diameter D50v of the clear powder coating material particles PCC3-2 is 3.8 μm, the volume particle diameter distribution index GSDv is 1.22, and the average circularity is 0.980.

Polyester Resin Clear Powder Coating Material (PCC4)

Clear powder particles (PCC4 type) are obtained by the same method as that of the clear powder particles (PCC1 type) except that when the volume average particle diameter of the aggregated particles becomes 13.5 μm in the aggregation step of the preparation of the clear powder particles (PCC1 type), 60 parts by weight of the polyester resin and curing agent composite dispersion (E1) is slowly put into the flask as the shell. Then, polyester resin clear powder coating materials (PCC4-1 and PCC4-2) are obtained by the same method as that of the polyester resin clear powder coating material (PCC1 type) except that the clear powder particles (PCC4 type) are used.

Furthermore, the volume average particle diameter D50v of the clear powder coating material particles PCC4-1 is 14.5 μm, the volume particle diameter distribution index GSDv is 1.29, and the average circularity is 0.944. The volume average particle diameter D50v of the clear powder coating material particles PCC4-2 is 14.3 μm, the volume particle diameter distribution index GSDv is 1.27, and the average circularity is 0.970.

Polyester Resin Clear Powder Coating Material (PCC5)
Polyester Resin (PES1): 65 parts by weight
Block Isocyanate Curing Agent VESTAGONB1530 (manufactured by Evonik Japan Co., Ltd.): 13 parts by weight

The compositions described above are mixed and are dissolved, and are kneaded and pulverized, and thus, clear powder particles (PCC5) are obtained. Then, a polyester resin clear powder coating material (PCC5) is obtained by the same method as that of the polyester resin clear powder coating material (PCC1) except that the clear powder particles (PCC5) are used.

Furthermore, the volume average particle diameter D50v of the clear powder coating material particles (PCC5) is 21.3 μm, and the volume particle diameter distribution index GSDv is 1.56. The average circularity is 0.910, and thus, the clear powder coating material particles have an irregular shape.

### Examples 1 to 4 and Comparative Examples 1 and 5

Electrostatic powder coating is performed as follows by using each of the powder coating materials (PCC1 type) to (PCC5).

Electrostatic Powder Coating

The powder coating material is put into a corona gun XR4-110C manufactured by ASAHI SUNAC CORPORATION. Furthermore, the powder coating material to be put into the corona gun corresponds to a powder coating material before being sprayed (a new product).

Then, a corona gun XR4-110C manufactured by ASAHI SUNAC CORPORATION is vertically and horizontally slid with respect to a square test panel (an object to be coated) of 30 cm×30 cm of a mirror finished aluminum plate by a distance of 30 cm from a panel front surface (a distance between the panel and a spray port of the corona gun), and thus, the powder coating material is sprayed and is electrostatically attached to the panel. The applied voltage of the corona gun is set to 80 kV, the input air pressure is set to 0.55 MPa, the discharge amount is set to 200 g/minute, and the thickness of the powder coating material which is attached to the panel is set to from 20 μm to 30 μm.

Then, the panel to which the powder coating material is electrostatically attached is put into a high temperature chamber which is set to 180° C., and is heated (baked) for 30 minutes. Thus, the panel is subjected to electrostatic powder coating by using an electrostatic powder before being sprayed (a new product).

Here, in the same conditions described above, the powder coating material is electrostatically attached to the panel. Then, the powder coating material which is electrostatically attached to the panel is collected, and the average circularity Sc of the powder particles (attached powder particles) in the attached powder coating material is measured.

On the other hand, the powder coating material which has not been electrostatically attached to the panel is collected, and the collected powder coating material and the powder coating material before being sprayed (a new product) are mixed at a weight ratio of 50:50, and thus, a mixed powder coating material is obtained. Then, in the same conditions described above, the panel is subjected to electrostatic powder coating by using the mixed powder coating material.

Smoothness Evaluation of Coating Film

In a coating film (in the table, described as “Coating Film of New Product”) at the time of performing the electrostatic powder coating with respect to the panel by using the powder coating material before being sprayed (the new product) and a coating film (in the table, described as “Coating Film of Collected Product”) at the time of performing the electrostatic powder coating with respect to the panel by using the mixed powder coating material, center line average roughness (hereinafter, described as “Ra”, Unit: μm) and a filtered waviness center curve (hereinafter, described as “Wca”, Unit: μm) are measured by using a surface roughness measurement machine (SURFCOM 1400A, manufactured by TOKYO SEIMITSU CO., LTD.). It is indicated that surface smoothness decreases as the number of Ra and Wca becomes larger.

On the other hand, the powder coating material before being sprayed (the new product) and the mixed powder coating material are stored for 48 hours under an environment of a temperature of 20° C. and humidity of 45% RH, and then, the same smoothness evaluation as described above is performed with respect to the coating film. Furthermore, in Table 1, the evaluation results of the smoothness of the coating film before storing the powder coating material are described in the section of “Immediately after being Prepared” and the evaluation results of the smoothness of the coating film after storing the powder coating material are described in the section of “after being Stored”.

The details and the evaluation results of the examples and the comparative examples are collectively shown in Table 1.

TABLE 1

| | | | | | Electrostatically | | Smoothness of Coating Film | |
|---|---|---|---|---|---|---|---|---|
| | Powder Coating Material before being Sprayed | | | | Attached Powder | | Surface Roughness Ra of Coating | |
| | (New Product) | | | | Coating Material | | Film of New Product | |
| | | Powder Particles | | | Powder Particles | | Ra (μm) | |
| | | | | Average | Average | Variation in | Immediately | |
| | | D50v | | Circularity | Circularity | Circularity | after being | After being |
| | No. | (μm) | GSDv | So | Sc | (Sc/So) | Prepared | Stored |
| Example 1 | PCC1-1 | 6.3 | 1.26 | 0.949 | 0.950 | 1.002 | 0.038 | 0.040 |
| Example 2 | PCC2-1 | 9.0 | 1.29 | 0.942 | 0.944 | 1.002 | 0.075 | 0.077 |
| Example 3 | PCC3-1 | 4.0 | 1.24 | 0.950 | 0.949 | 0.999 | 0.037 | 0.040 |
| Example 4 | PCC4-1 | 14.5 | 1.29 | 0.944 | 0.942 | 0.998 | 0.061 | 0.060 |
| Comparative | PCC1-2 | 6.1 | 1.24 | 0.980 | 0.960 | 0.980 | 0.035 | 0.039 |
| Example 1 | | | | | | | | |
| Comparative | PCC2-2 | 9.2 | 1.25 | 0.980 | 0.970 | 0.990 | 0.070 | 0.072 |
| Example 2 | | | | | | | | |
| Comparative | PCC3-2 | 3.8 | 1.22 | 0.980 | 0.980 | 1.000 | 0.031 | 0.035 |
| Example 3 | | | | | | | | |
| Comparative | PCC4-2 | 14.3 | 1.27 | 0.970 | 0.950 | 0.979 | 0.056 | 0.057 |
| Example 4 | | | | | | | | |
| Comparative | PCC5 | 21.3 | 1.56 | 0.910 | 0.800 | 0.879 | 0.055 | 0.057 |
| Example 5 | | | | | | | | |

| | Smoothness of Coating Film | | | | | |
|---|---|---|---|---|---|---|
| | Surface Roughness Ra of Coating | | Surface Roughness Ra of Coating | | | |
| | Film of New Product | | Film of Collected Product | | | |
| | Wca (μm) | | Ra (μm) | | Wca (μm) | |
| | Immediately | | Immediately | | Immediately | |
| | after being | After being | after being | After being | after being | After being |
| | Prepared | Stored | Prepared | Stored | Prepared | Stored |
| Example 1 | 0.044 | 0.048 | 0.040 | 0.044 | 0.045 | 0.050 |
| Example 2 | 0.095 | 0.098 | 0.076 | 0.077 | 0.096 | 0.097 |
| Example 3 | 0.041 | 0.046 | 0.039 | 0.040 | 0.043 | 0.048 |
| Example 4 | 0.123 | 0.130 | 0.063 | 0.064 | 0.125 | 0.129 |
| Comparative | 0.042 | 0.068 | 0.040 | 0.047 | 0.072 | 0.101 |
| Example 1 | | | | | | |
| Comparative | 0.092 | 0.102 | 0.076 | 0.080 | 0.122 | 0.158 |
| Example 2 | | | | | | |
| Comparative | 0.039 | 0.069 | 0.037 | 0.043 | 0.067 | 0.100 |
| Example 3 | | | | | | |
| Comparative | 0.124 | 0.175 | 0.061 | 0.065 | 0.133 | 0.201 |
| Example 4 | | | | | | |
| Comparative | 0.201 | 0.287 | 0.087 | 0.093 | 0.247 | 0.302 |
| Example 5 | | | | | | |

From the results described above, in this example, compared to the comparative example, it is found that a difference in the surface roughness Ra and the filtered waviness center curve Wca between the coating film of the new product and the coating film of the collected product after storing the powder coating material is small, and a variation in smoothness of a coating film which occurs at the time of storing and reusing the powder coating material collected without being electrostatically attached to an object to be coated is prevented.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic powder coating method, comprising:
spraying a charged powder coating material that includes powder particles which contain a thermosetting resin and a thermosetting agent and have an average circularity of 0.940 to 0.950 to electrostatically attach the powder coating material to an object to be coated; and
heating the powder coating material that is electrostatically attached to the object to be coated to thereby form a coating film,
wherein an average circularity Sc of the powder particles in the powder coating material that is electrostatically attached to the object to be coated and an average circularity So of the powder particles in the powder coating material before being sprayed satisfy a relationship of Expression: So×0.90≦Sc≦So×1.05.

2. The electrostatic powder coating method according to claim 1,
wherein the average circularity Sc of the powder particles in the powder coating material that is electrostatically attached to the object to be coated and the average circularity So of the powder particles in the powder coating material before being sprayed satisfy a relationship of Expression: So×0.95≦Sc≦So×1.02.

3. The electrostatic powder coating method according to claim 1,
wherein the thermosetting resin is a thermosetting polyester resin.

4. The electrostatic powder coating method according to claim 3,
wherein a total of an acid value and a hydroxyl value of the thermosetting polyester resin is from 10 mgKOH/g to 250 mgKOH/g.

5. The electrostatic powder coating method according to claim 3,
wherein a number average molecular weight of the thermosetting polyester resin is from 1,000 to 100,000.

6. The electrostatic powder coating method according to claim 1,
wherein the thermosetting resin is a thermosetting (meth)acrylic resin.

7. The electrostatic powder coating method according to claim 6,
wherein a number average molecular weight of the thermosetting (meth)acrylic resin is from 1,000 to 20,000.

8. The electrostatic powder coating method according to claim 1,
wherein a content of the thermosetting resin is from 20% by weight to 99% by weight with respect to the total content of the powder particles.

9. The electrostatic powder coating method according to claim 1,
wherein a volume average particle diameter of the powder particles in the powder coating material before being sprayed is from 3 μm to 10 μm.

10. The electrostatic powder coating method according to claim 1,
wherein a volume particle diameter distribution index GSDv of the powder coating material is less than or equal to 1.40.

11. The electrostatic powder coating method according to claim 1,
wherein the powder coating material before being sprayed includes silica particles as an external additive.

12. The electrostatic powder coating method according to claim 11,
wherein a volume average particle diameter of the silica particles is from 5 nm to 200 nm.

13. The electrostatic powder coating method according to claim 11,
wherein an externally added amount of the silica particles is from 0.01% by weight to 5% by weight with respect to the powder particles.

14. The electrostatic powder coating method according to claim 1,
wherein the powder particles include a bivalent or higher valent metal ion.

15. The electrostatic powder coating method according to claim 14,
wherein a content of the bivalent or higher valent metal ion is from 0.002% by weight to 0.2% by weight with respect to the total content of the powder particles.

16. The electrostatic powder coating method according to claim 1,
wherein a content of the thermosetting agent is from 1% by weight to 30% by weight with respect to the thermosetting resin.

17. The electrostatic powder coating method according to claim 1,
wherein the powder particles are core-shell particles.

18. The electrostatic powder coating method according to claim 1,
wherein a film thickness of the coating film is from 10 μm to 150 μm.

19. The electrostatic powder coating method according to claim 1,
wherein the heating is performed at a heating temperature of from 90° C. to 250° C.

20. A powder coating material, comprising:
powder particles that contain a thermosetting resin and a thermosetting agent and have an average circularity of 0.940 to 0.950,
wherein, when the powder coating material is sprayed and the powder coating material is electrostatically attached to an object to be coated, an average circularity Sc of the powder particles in the powder coating material that is electrostatically attached to the object to be coated and an average circularity So of the powder particles in the powder coating material before being sprayed satisfy a relationship of Expression: So×0.90≦Sc≦So×1.05.
